(19) United States
(12) Patent Application Publication
(10) Pub. No.: US 2007/0203874 A1
(43) Pub. Date: Aug. 30, 2007

(54) System and method for managing files on a file server using embedded metadata and a search engine

(75) Inventors: Ellis K. Cave, Plano, TX (US); Michael J. Polcyn, Allen, TX (US)

Correspondence Address: FULBRIGHT & JAWORSKI L.L.P, 2200 ROSS AVENUE, SUITE 2800, DALLAS, TX, 75201-2784, US

(73) Assignee: InterVoice Limited Partnership, Dallas, TX (US)

(21) Appl. No.: 11/361,847

(22) Filed: Feb. 24, 2006

(51) Int. Cl. G06F 17/30

(52) U.S. Cl. 707/1

(57) ABSTRACT

There is disclosed a system and method for storing metadata information in files. When each file is stored in a file server an index of the stored metadata is also stored such that when a query is subsequently presented to the file server, the query is used by a search engine to identify and retrieve the desired file. In one embodiment, the files are audio messages for use in an Interactive Voice Response (IVR) system and the audio messages are stored on a audio file server.

### CONCURRENTLY FILED APPLICATIONS

The present application is related to copending and commonly assigned U.S. patent application Ser. No. _____ [Attorney Docket No. 47524-P138US-10501429] entitled “SYSTEM AND METHOD FOR RETRIEVING FILES FROM A FILE SERVER USING FILE ATTRIBUTES,” patent application Ser. No. ______ [Attorney Docket No. 47524-P139US-10503962] entitled “SYSTEM AND METHOD FOR RETRIEVING FILES FROM A FILE SERVER USING FILE ATTRIBUTES,” and patent application Ser. No. ______ [Attorney Docket No. 47524-P140US-10506201] entitled “SYSTEM AND METHOD FOR DEFINING, SYNTHESIZING AND RETRIEVING VARIABLE FIELD UTTERANCES FROM A FILE SERVER,” filed concurrently herewith, the disclosures of which are hereby incorporated by reference.

### TECHNICAL FIELD

This invention relates to file storage, organization, and in general and more particularly to the managing of files on a file server using metadata that is embedded into the files and search engine indexing.

### BACKGROUND OF THE INVENTION

It is now commonplace to retrieve data files from storage locations. In the simplest situation, files are stored on the same system handling the request for the file. Situations arise where it is desired to have several systems access a common set of files. This can be accomplished by setting up a file storage arrangement that is shared across a network. In such file storage arrangements, whether the arrangement serves one system or a plurality of systems, the desired file is retrieved by specifying the name of the file, as well as the full directory path to the file, when required. Thus, files may be moved about over the network arbitrarily.

Such an arrangement has problems when metadata is associated with the various files. Typically, metadata associated with a file is placed in a separate database. Thus, the database must be moved each time a file is moved.

In addition, the storage of files is typically done by placing the file in a folder, somewhere in hierarchical directory structure. Hierarchical storage structures have a limitation in that they require the person filing a document to pick a specific attribute about that file so that a specific folder can be selected to store the file in. However, a file may have several attributes (for example author, subject, language, etc.) that are important to that file. The dilemma faced by the person creating the file structure is how to create a hierarchical structure where some people want to find the files by one attribute, such as author, while other people may want to find the files by another attribute, such as subject, and while still others by language. In order to allow the same document to be found in by searching different attributes, e.g. the author, subject, and language folders, one would need to create three copies of the document, and put one copy in each type folder.

One example of a complex file structure is the audio file structure used in interactive voice response (IVR) systems.

### BRIEF SUMMARY OF THE INVENTION

In one embodiment, an audio file could have an attribute such as the language that the file was recoded in, and a second attribute that was the name of the person that recorded the file. These metadata attributes, the language of the recording and the name of the recorder, can be embedded into the file as metadata. The file attributes or file metadata are embedded in the file in such a way that the metadata does not interfere with the normal operation and/or use of the file.

Metadata as described in this patent consists of a list of attributes. Each attribute has a data value that defines the attribute. For example, an attribute of an audio file could be the language that the file was recorded in. The data value would be “English” and the attribute/value pair could be described as “Language=English.” If the person that recorded the file was named John, the attribute value pair would be “Recorded By=John.”

Once each file in a set of files has been modified with embedded metadata, the file set can be placed on a file server or on any type of electronic storage media or system. With file set having embedded metadata, indexing techniques and a search engine can be used to organize indexing structures and find the files without having to define any pre-determined file structure. All of the files can be kept in a single folder, and the search engine can be used to find any file from its attributes. Embodiments of the invention involve putting a file with embedded metadata into the server. When a new file is received by the file server, the metadata embedded in the file is extracted, and indexed. The indexed metadata is stored in one or more metadata index(s) for later use by the search engine. The index(s) includes every attribute type that appears in any of the files that are stored on the file server. The file itself can be placed with all of the other files in a generic folder, as long as the file has a unique name from the other files. The indexing structure will maintain pointers to the actual file location on the server.

When a process or a user needs to retrieve a file(s) from the file server, the metadata attribute(s) of the desire file(s) must be communicated to the file server. The server then invokes the search engine, which pulls the metadata attributes from the request. The search engine looks up the required attributes in the index file, and extracts a list of file names that match the requested attributes. The file server can then return one or more of the files that match the requested attribute list. A specific set of requested attributes can return too many files. In this case, the process or users may want to narrow the search. This can be done by specifying additional attributes.

A specific use of a metadata-enhanced file server is an audio file server (AFS) for use in interactive voice recognition (IVR) systems. When an audio file is placed on an AFS the indexing engine of the AFS is used to extract the metadata and index it. When a set of audio files are loaded onto the audio file server, the server examines each audio file, and extracts the metadata associated with that file. The file server then places each audio file's metadata into the appropriate searchable index for easy discovery when retrieval requests are made. The searchable index kept by the audio file server lists every attribute type that appears in any of the files that are stored on the file server. For example, if an administrator or user wants to find all of the audio files recorded by John on the file server, the index is queried for the “recorded by” attribute set equal to “John” and the index will return pointers to all of the audio files recorded by anyone with “John” in their name. If the administrator wants to narrow the search, additional attributes can be specified, such as requiring that the server find only audio files where John says “Hello World” in English. There still may be more than one audio file that matches this attribute set, as John may have recorded several versions of “Hello World,” with different emotional inflections: stern, happy, sad. Again, the administrator can narrow the search by specifying even more attributes, such as emotional inflection.

When writing an interactive voice script, the developer usually desires only one message to be returned by the audio file server for playback. This can normally be accomplished by simply specifying enough independent attributes to allow the audio file server to resolve the selection down to a single audio file. In situations where the request resolves down to more than one file, the AFS randomly picks one of the selected files to return to the requester. In some situations, the requestor may ask for a list of the selected files to be returned, instead of the actual files.

### BRIEF DESCRIPTION OF THE DRAWINGS

For a more complete understanding of the present invention, reference is now made to the following descriptions taken in conjunction with the accompanying drawings, in which:

FIG. 1 depicts an overview of an exemplary arrangement of a file storage system involving embodiments of the invention; and

FIG. 2 depicts an exemplary method for using a file system involving embodiments of the invention;

FIG. 3 depicts an exemplary method for putting a file on a file server involving embodiments of the invention;

FIG. 4 depicts an exemplary method for retrieving a file from a file server involving embodiments of the invention;

FIGS. 5A and 5B depict examples of metadata stored within file according to embodiments of the invention; and

FIG. 6 shows depicts a block diagram of a computer system which is adapted to use the present invention.

### DETAILED DESCRIPTION OF THE INVENTION

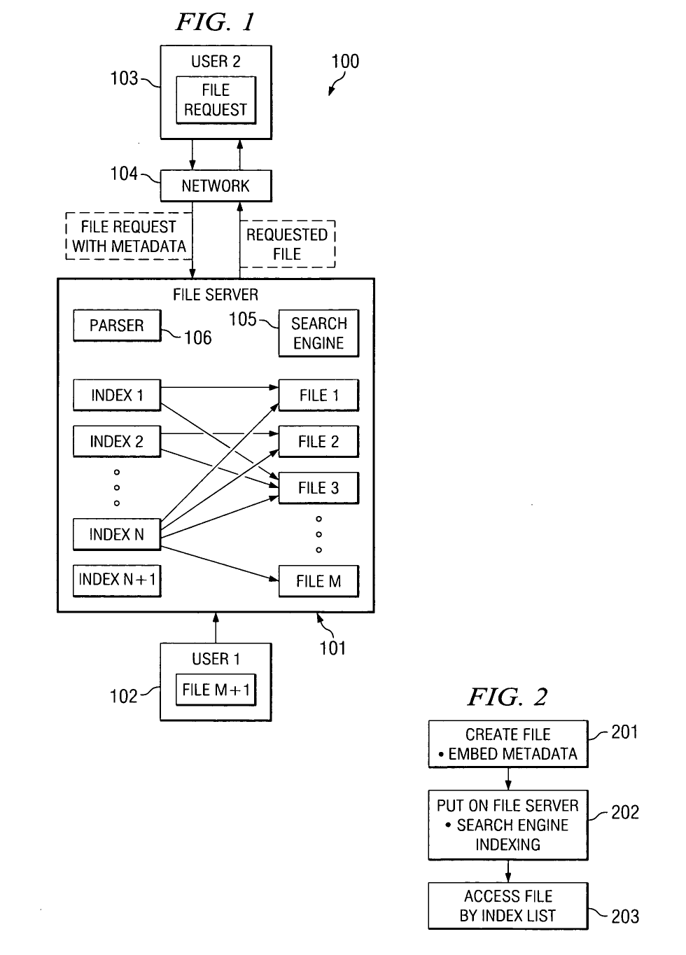

FIG. 1 shows one embodiment 100 of a file storage system having a process or user 102 that puts a file onto the system 101 and another process or user 103 that desires to retrieve a file from the system. Note that one or more users may be connected to the file server 101 via a direct connection or non-network connection, such as user 1 102. Further note that one or more users may be connected to the file server 101 via network 104, such as user 2 103. The network may be a LAN, a WAN, a WIFI, the Internet, or other network connection. Note that user 1 102 may be connected to the server via a network connection, and user 2 103 may be directly connected to the server. However, the user can use a local metadata search engine to find the locations of the files with the attributes they seek, as long as they have indexed all the files on their system.

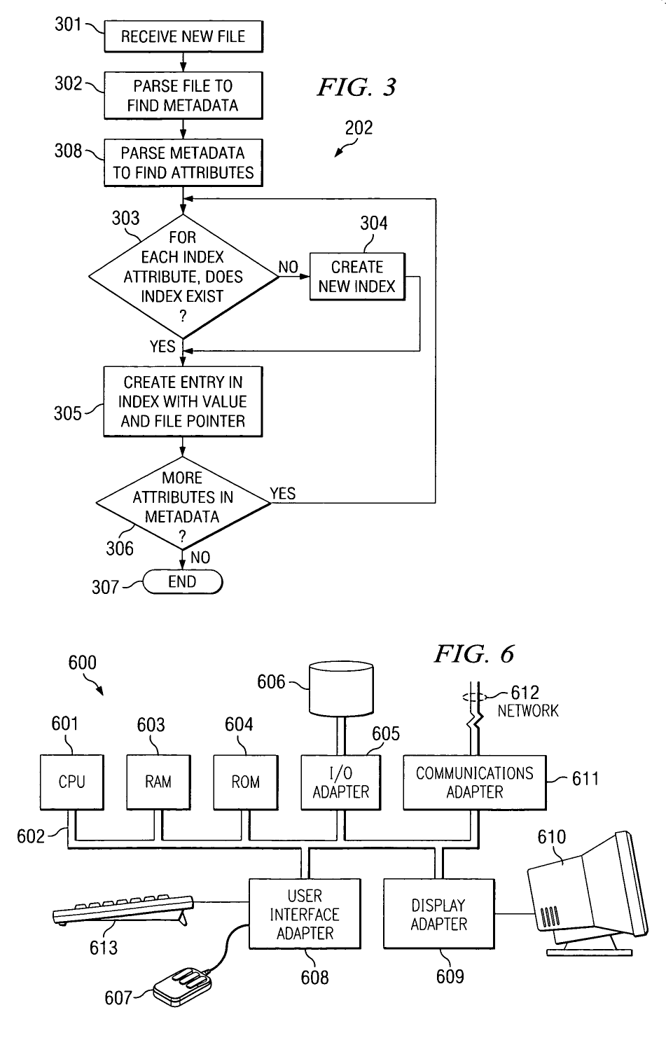

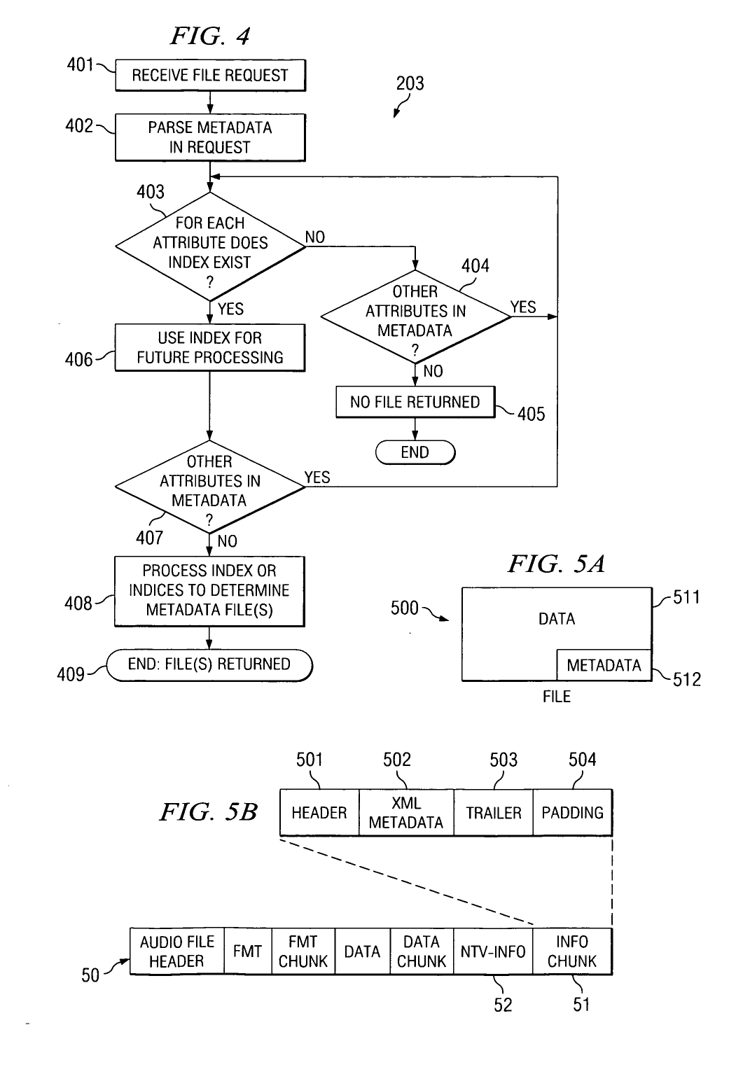

In the system of FIG. 1, user 1 102 is putting file M+1 onto file server 101, while user 2 103 has a file request to retrieve a file from the file server. FIGS. 3 and 4, respectively define examples of processes to handle the desired operations of users 1 and 2.

The file server 101 includes a plurality of files, namely file 1 to file M, a search engine 105, and a plurality of indices, namely index 1 to index N+1. The search engine created the plurality of indices from metadata attributes of the files. The search engine 105 uses the plurality of indices to locate a particular file or files to satisfy a file request by a user or a process.

FIG. 2 depicts an exemplary method 200 of operating a file storage system, for example, the file storage system 100 of FIG. 1. In the method 200, a file is created in block 201 and is embedded with metadata that defines aspects of the file using attributes. The metadata is stored in the file and not in separate file. For example, suppose a file comprises a text document that is written in a blue Times New Roman font and includes the content of ‘hello world’ and is written in English. A portion of the file would include metadata attributes (and their respective values) such as file-type (text), color (blue), font (Times New Roman), content (‘hello world’), and language (English).

It is preferred to embed the metadata during file creation, however, existing files without metadata may be modified to include embedded metadata and then restored on the system to index the file at any time, as long as the indexing process is notified to re-index the modified file after the modifications. Metadata may also be embedded into a file before the data is formed dr placed into the file. Furthermore, existing files may be subsequently modified to include new or different attribute(s) and then restored on the system to re-index the file. For example, using the previously defined text file, suppose a user desired to add the attribute that defines the program that is used to write the text file, e.g. program (WORD). The existing metadata would be edited to include the new metadata and then the file is restored on the system.

Advantages may be realized by storing the metadata in the file. One advantage is that by storing the information in the file, it will be readily accessible wherever copies of the file are made available. This information can then be accessed by subsequent automated processes or live users, to perform various tasks with the files. This is opposed to storing the metadata in a database external to the files, so that copies of the database must accompany the files whenever the metadata must be accessed.

Some typical metadata elements that are specific to audio files which may be placed in files, are the name of the person that recorded the file, the language that was used in the recording, the text transcription of what was recorded, the inflection, the recording date, translations of the file into other languages, etc. After the metadata has been placed in the file, subsequent processes or users can examine that data to make decisions about what to do with the audio file.

With embedded attribute metadata, anyone with a copy of the audio file and a proper tool can determine information about the file without having to listen to the file or obtain a copy of a metadata database containing all the file's metadata. Various specialized tools can be used to view the metadata in the file, so either an automated process or a live user can access the attribute metadata.

In FIG. 2, the file server is then provided with a file(s) that includes embedded metadata, and the method puts the file(s) on the file server in block 202. The file server then indexes the file and stores the file along with the other files. Indexing may occur during start up and/or during run time. FIG. 3 depicts an exemplary method for putting a file on a file server, for example, the file server 101 of FIG. 1. FIG. 3 begins when the file server receives a new file that is to be stored in the file server, block 301. The search engine 105 of the file server parses the file to find the metadata in the file block 302. Then the search engine parses the metadata to find all the attributes 308. The search engine then determines whether an index exists for each of the metadata attributes, block 303. If an index exists then the search engine creates an entry in the index that includes the value for the attribute and a pointer to the file, block 305. If there is no corresponding index, then the search engine creates a new index, block 304 before moving to block 305. The search engine then determines whether there are any more attributes in the metadata. If so, then the search returns to block 303 for further processing. If not, then the process ends, block 307.

In FIG. 2, after putting the file on the file server, the file server may then search and access a particular file by using metadata in a search request and the indices, block 203. FIG. 4 depicts an exemplary method for retrieving a file from a file server, for example, the file server 101 of FIG. 1. FIG. 4 begins when the file server receives a request to access a file, block 401. The search engine parses the metadata attributes and values from the request, block 402. The search engine then determines whether there is a match between an attribute value and value in a corresponding index, block 403. If there is not a match, then there are no files that match the search request, and the method ends with no file(s) being returned, block 405. If there is a match, then the search engine uses the match for further processing, block 404. Note that there may be more than one matching file. The method then determines if there are further attributes in the request, block 406. If so, then the method returns to block 403 for further processing. If not, then the method progresses to block 407, where the search engine processes the matches. The search engine then determines which file(s) match all of the attribute values in the request. If there are none, then there are no files that match the search request, and the method ends with no file(s) being returned, block 405. If there is at least one, then the method ends by returning the file(s) to the user or process, block 409. Note that the method may alternatively end by returning a listing of the matching files instead of or in addition to returning the actual files. Further note that the method of FIG. 4 is exemplary in nature, a more complex search method may provide search results that show partial file matches, e.g. where files may have matched some but not all of the attribute values in the file request.

The metadata that is stored in the data file and/or used in the file request may be in the form of a key/value pair. For example, using the above-reference text file example, key value pairs may be expressed as file-type=text, color=blue, font=Times New Roman, content=‘hello world’, and language=English. The indices stored in the file server would include the values and a pointer to the associated file. Continuing with the example, one index would be language, with one entry in the language index being the value English and having a pointer to the text file. Another entry may comprise the value French with a pointer to another file. A further entry may comprise the value English with a pointer to a further file.

The structure or format of the metadata inside of the files in this embodiment is in Adobe's XMP (Extensible Metadata Platform) format. XMP has a particularly useful attribute. The metadata attributes in an XMP structure embedded in a file can be discovered in that file, even if the examining entity has no idea what kind of file it is or what is the structure or format of the file.

Indexing the metadata for a group of audio files, and using search engine techniques to find the metadata matches allows a user or process to obtain a specific audio file from a large group of files. For example, if a user wants to select one or more files from a large group of audio files the user would specify the attributes that the required file(s) must have. For example, suppose that the user wants audio files that were recorded by John, in English, and that say “Hello World”. There may be more than one file that matches this criteria, but in any case, that is what the user specifies. The metadata is sent to the storage system which then uses an indexing search engine to find and retrieve the desired file(s). If desired, the search engine can be used to make a list of the files that match the defined attribute criteria.

Using metadata to retrieve a desired file is particularly useful in IVR or voice automation systems, where prerecorded audio files or messages are played to callers on the phone. The selection of these prerecorded messages can be a complex process, as languages, speakers, and emotional tone of the conversation may change dynamically during an automated conversation between a caller and an automated system.

FIG. 5A depicts an example of metadata 512 stored within a non-specific data file 500, along with the data 511. FIG. 5B depicts an specific example of metadata 502 stored within an audio file 505 in a standard .wav format. The metadata is in an Extensible Metadata Platform (XMP) packet 502 embedded in audio file 50. This example is specific to .wav files with their Resource Interchange File Format (RIFF). To embed metadata it is typically necessary to know the structure of a specific file format, but if certain structures such as Adobe's XMP metadata format is used to contain the metadata, extracting the metadata can be done without knowing the file structure.

Packet 50 shows an audio file which preferably is a Resource Interchange File Format (RIFF) file which is the basis for the .wav format which was defined by Microsoft. This format is in chunks with a header for each chunk. Some chunks, such as chunk 52, are reserved for information about the file. Some chunks, such as chunk 51, are reserved for private use. The rule is that if an application that uses the file does not know what is in a chunk, ignore that chunk, but not remove it. Thus, chunk 51 is ignored, unless a reader (user) is programmed to deal with it. Using such a chunk defined specifically as an XMP metadata container, it is possible to put metadata into the file.

It is possible to use Adobe's protocol called Extensible Metadata Platform (XMP) which is an open standard for metadata and to define all the metadata elements using the XMP protocol. The XMP metadata block is discoverable by a metadata tool without knowing the format of the file. The XMP metadata format contains a unique code sequence at the beginning of the XMP data block. Thus, it is possible to scan through the file looking for a particular code sequence. Once that sequence is found the XMP metadata block will immediately follow, so the metadata it can be read without knowing anything about how the file is put together.

Chunk 51 can have embedded therein segment 501 (header) which is the unique code mentioned in the previous paragraph, segment 502 (metadata), segment 503 (trailer) and segment 504 (padding). The metadata can be, for example, the name of the VoiceXML document; the author of the VoiceXML; the date when the document was written; the description of what the message says; the language; etc.

Note that any of the functions described herein may be implemented in hardware, software, and/or firmware, and/or any combination thereof. When implemented in software, the elements of the present invention are essentially the code segments to perform the necessary tasks. The program or code segments can be stored in a processor readable medium. The “processor readable medium” may include any medium that can store or transfer information. Examples of the processor readable medium include an electronic circuit, a semiconductor memory device, a ROM, a flash memory, an erasable ROM (EROM), a floppy diskette, a compact disk CD-ROM, an optical disk, a hard disk, an optic medium, etc. The code segments may be downloaded via computer networks such as the Internet, Intranet, etc.

FIG. 6 illustrates computer system 600 adapted to use the present invention. Central processing unit (CPU) 601 is coupled to system bus 602. The CPU 601 may be any general purpose CPU, such as an HP PA-8500 or Intel Pentium processor. However, the present invention is not restricted to the architecture of CPU 601 as long as CPU 601 supports the inventive operations as described herein. Bus 602 is coupled to random access memory (RAM) 603, which may be SRAM, DRAM, or SCRAM. ROM 604 is also coupled to bus 602, which may be PROM, EPROM, or EEPROM. RAM 603 and ROM 604 hold user and system data and programs as is well known in the art.

Bus 602 is also coupled to input/output (I/O) controller card 605, communications adapter card 611, user interface card 608, and display card 609. The I/O adapter card 605 connects to storage devices 606, such as one or more of a hard drive, a CD drive, a floppy disk drive, and/or a tape drive, to the computer system. Storage devices 606 may be used to store the files and indices of FIG. 1. The I/O adapter 605 is also connected to printer 614, which would allow the system to print paper copies of information such as document, photographs, articles, etc. Note that the printer may be a printer (e.g. dot matrix, laser, etc.), a fax machine, or a copier machine. Communications card 611 is adapted to couple the computer system 600 to a network 612, which may be one or more of a telephone network, a local (LAN) and/or a wide-area (WAN) network, an Ethernet network, and/or the Internet network. User interface card 608 couples user input devices, such as keyboard 613, pointing device 607, and microphone 616, to the computer system 600. User interface card 608 also provides sound output to a user via speaker(s) 615. The display card 609 is driven by CPU 601 to control the display on display device 610.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A file storage system comprising:
a plurality of files;
means for receiving requests for selected ones of said files, said request comprising:
list of attribute/value pairs of said selected files; and
means for retrieving requested files by parsing said attributes associated with said request.

2. The file storage system of claim 1 further comprising:
a requesting system and wherein said receiving means comprises a communication mechanism for communicating said attributes to said storage system.

3. The file storage system of claim 2 wherein said attributes are contained in metadata associated with the desired files.

4. The file storage system of claim 2 further comprising:
a file server for storing said plurality of files providing said request and said attributes to said file server in a URL; and
means for communicating retrieved ones of said files to said requesting system.

5. The file storage system of claim 2 wherein said retrieving means comprises:
means for identifying the universe of files matching said key/value pairs; and
wherein said retrieving means communicates a list of said identified universe of files to said requesting system.

6. The storage system of claim 1 wherein said retrieving means comprises:
an indexing store for storing said attributes of said files.

7. The file storage system of claim 1 wherein at least some of said files are audio files.

8. A voice file audio file server comprising:
a system for selecting a voice file from among a plurality of voice files, said system operative to parse attributes of said voice file associated with requests received for said voice file.

9. The voice file audio file server of claim 8 wherein said requests include identification of a particular file together with attributes which further uniquely identify one voice file from a plurality of voice files matching said identification.

10. The voice file audio file server of claim 9 wherein said voice file is retrieved in a format that allows metadata to be imbedded therein.

11. The voice file audio file server of claim 8 wherein said requests arrive at said audio file server as a plurality of key/value pairs.

12. A web based IVR system comprising:
an application server for providing control for various applications that are available to users;
a voice browser interposed between said application server and said users, said voice browser operable for interfacing audio commands to/from said user and said application server and wherein certain of said commands from said application server contain requests identifying audio messages to be delivered to said user; and
a audio file server for receiving requests for audio files under control of said voice browser, said audio file server operable for retrieving a requested existing audio file for delivery to said user, wherein said retrieved audio file is identified by attributes associated with said requested file.

13. The system of claim 12 wherein said requests come to said voice browser on a HTTP protocol communication line using the VXML protocol.

14. The system of claim 12 wherein at least some of said audio files have been stored by a system user.

15. The system of claim 12 wherein said audio file server comprises:
means for indexing said attributes of said audio files; and
means for searching said index for a file associated with said attributes.

16. The system of claim 12 wherein said audio file server further comprises:
an indexing engine for matching attributes associated with said request with attributes stored in association with said messages.

17. A method for retrieving files from a file server, said method comprising:
sending a file request to said file server, said file containing metadata pertaining to a file to be retrieved from said file server; and
resolving the storage location of said specifically desired file by said file server, based on said metadata contained in said file request.

18. The method of claim 17 wherein said resolving further comprises:
receiving a text identification of said desired file together with attributes for further defining said desired file from among the universe of files that otherwise would match said text identification.

19. The method of claim 18 wherein said text identification and said attributes are communicated as a synthetic query.

20. The method of claim 19 wherein said synthetic query is a plurality of key/value pairs.

21. A audio file server comprising:
memory for storing therein files containing audio messages, said messages selectable under control of identification requests; and
a searchable index linking metadata contained in said identification requests with metadata contained in specific ones of said audio message files.

22. The server of claim 21 wherein said identification requests are received from an external source; said system further comprising:
a search engine for searching said searchable index in response to received ones of said identification requests.

23. The server of claim 22 wherein said received requests use the HTTP protocol over a communication link.

24. The server of claim 21 wherein said identification requests contain attributes of a desired audio message and wherein said attributes are contained in said metadata.
